(19) United States
(12) Patent Application Publication
(10) Pub. No.: US 2009/0292761 A1
(43) Pub. Date: Nov. 26, 2009

(54) BYPASS DSMCC MIDDLEWARE VIA SECTION FILTER MECHANISM

(75) Inventors: Joannes H.M. Lemmers, Reek (NL); Petrus Wouters, Oostelbeers (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/721,485

(22) PCT Filed: Dec. 13, 2005
(86) PCT No.: PCT/IB2005/054223

§ 371 Date: Jun. 12, 2007

Related U.S. Application Data
(60) Provisional application No. 60/635,679, filed on Dec. 13, 2004.

(51) Int. Cl. G06F 15/16

(52) U.S. Cl. 709/203

(57) ABSTRACT

A desired file (182) of a filesystem (105) is recovered from a data stream (160) for use by a multimedia services application (181, 252) at a client (150), such as a Multimedia Home Platform (MHP) client. The DSMCC module (175) in the middleware (254) of the client is bypassed to avoid potential problems and reduce computational complexity. The filesystem is provided in modules (130, 140, 150), while the modules are provided in sections (161, 163, 165, 167), in a Digital Storage Media-Command and Control (DSM-CC) carousel. The multimedia services application recovers the desired file directly by filtering the data stream to recover the sections, and recover a module from the recovered sections, using an associated identifier. The multimedia services application recovers the desired file from the recovered module using an object key that indicates the location of the desired file in the recovered module.

The invention relates generally to a method and system for downloading a file of a filesystem of a multimedia broadband service from a server to a client and, more particularly, to a streamlined technique for directly retrieving a file at the client from a data stream via a section filter.

Multimedia broadband services have become increasingly popular due to the variety of applications that can be provided. These include, e.g., electronic program guides, information services, play-along games, e-commerce, secure transactions and educational applications. Furthermore, such services often employ Digital Storage Media-Command and Control (DSM-CC), which is an ISO/IEC standard for the delivery of multimedia broadband services. DSM-CC is an open protocol that allows set-top boxes, personal computers (PCs) and other information appliances to access multiple services from multiple service providers. DSM-CC supports both an interactive, flow-controlled download and a non-flow controlled, or broadcast, download.

Moreover, the Multimedia Home Platform (MHP) defines a generic interface between interactive digital applications and the terminals on which those applications execute. It enables digital content providers to address different types of terminals, including set-top boxes, integrated digital TV sets and multimedia PCs. The architecture of the MHP includes resources, system software and applications layers.

In particular, the MHP digital TV specification uses DSMCC to transfer a filesystem from the broadcaster/server to the receiver/client. In one approach, the Java classloader and the MHP application at the client require a filesystem to obtain code, images and data. On the application (top) level, DSMCC provides access to a directory structure with a file and its contents. That is, when the application accesses a DSMCC carousel containing one file system, it sees a file system with directories and files. At the broadcast (bottom) level, the directory structure includes a broadcast of multiple modules, each containing one or multiple files and directory-files. These files and directories can be broadcast using MPEG2, for instance, where the files are organized with various control messages and modules, and broadcast in sections.

However, some MHP implementations have problems in detecting an update in the broadcast of a specific file because the middleware is very complex and DSMCC broadcasts can be very complex. In particular, the available middleware has problems with file updates in a DSMCC carousel. When the client application encounters such a detection problem, it is not able to retrieve a newly broadcast file and the newly broadcast content. Furthermore, with multiple DSMCC carousels, it becomes quite computationally expensive to access a single desired file, especially when the file is a few directories deep in the filesystem. The MHP system has first to mount the carousel, e.g., start the filesystem, and access all the directory-files to figure out in which module the required file is positioned.

The present invention addresses the above and other issues by providing a method and system for speeding up the downloading of one or more files of a filesystem of a multimedia broadband at a client and, more particularly, to a technique for directly retrieving one or more desired files from a received data stream via a section filter.

In particular, in one aspect of the invention, a method is provided for recovering at least one desired file of a filesystem from a data stream received at a client, wherein the filesystem is provided in a plurality of modules, and the plurality of modules are provided in a plurality of sections. The method includes configuring a multimedia services application running at the client with information for recovering the at least one desired file from the data stream, wherein the information includes: (a) a first identifier for identifying the at least one desired file within one of the plurality of modules, and (b) a second identifier for identifying the one of the plurality of modules. The method further includes filtering the data stream, responsive to the multimedia services application, to recover the sections in which the one of the plurality of modules is carried, and, using the second identifier, recover the one of the plurality of modules from the recovered sections. The method further includes using the multimedia services application to recover the at least one desired file from the recovered one of the plurality of modules, according to the first identifier.

In a further aspect of the invention, a method is provided for verifying a recovered file of a filesystem from a data stream received at a client, wherein the filesystem is provided in a plurality of modules, and the plurality of modules are provided in a plurality of sections. The method includes: (a) configuring a multimedia services application running at the client with information for recovering the at least one desired file from the data stream, (b) filtering the data stream, responsive to the multimedia services application, to recover at least the sections in which the one of the plurality of modules is carried, and recover the one of the plurality of modules from the recovered sections, (c) verifying that the recovered sections have a common version identifier to ensure the recovered one of the plurality of modules is valid, and (d) responsive to the verifying, using the multimedia services application to recover the at least one desired file from the recovered one of the plurality of modules.

The sections that are recovered may be limited to sections having an expected version identifier.

A corresponding client apparatus and program storages device are also provided.

In the drawings:

In all the Figures, corresponding parts are referenced by the same reference numerals.

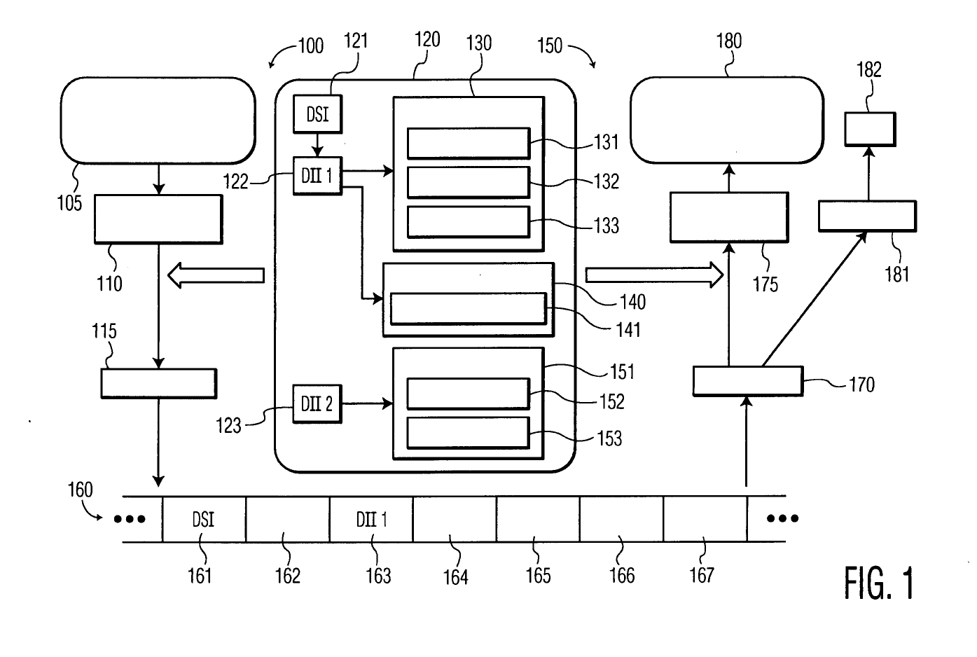

FIG. 1 illustrates a schematic diagram of the transfer of a filesystem, and the recovery of a file, according to the invention; and

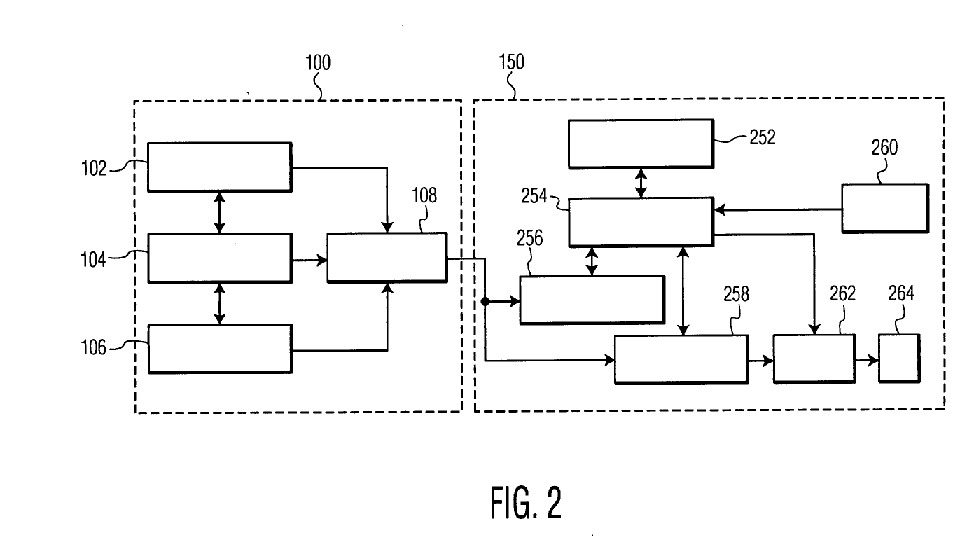

FIG. 2 illustrates a block diagram of a server and a client for achieving the recovery of a file as indicated in FIG. 1, according to the invention.

The present invention addresses problems that occur when attempting to recover files of a filesystem using middleware of a multimedia service client such as an MHP client. Note that the invention is also applicable to OCAP, the interactive TV standard for US cable networks, which is related to MHP, but is based on ATSC instead of DVB. The stated goal is achieved by bypassing the middleware, such as the DSMCC API, and directly retrieving the filesystem modules, such as DSMCC modules, from the received data stream using a section filter. The filesystem contents can be extracted from the retrieved modules. To retrieve a DSMCC module via a section filter, the application uses the DSMCC packet identifier (PID) and module identifier. Moreover, to retrieve a specific file of the filesystem, a file-key or object key is used. This configuration data can be provided to the multimedia services application by hard coding the data into the application or via a configuration file, for instance.

The advantages of this approach include enabling the application to bypass MHP middleware update problems, and enabling the application to retrieve a file in one DSMCC cycle in every carousel at any location, thereby speeding up the process. That is, a desired file can be recovered in no more than one cycle of the carousel.

FIG. 1 illustrates a schematic diagram of the transfer of a filesystem, according to the invention. Blocks 105 and 180 both read (first line) “\application\code.class”, (second line) “\images\background.gif” and (third line) “\data\content.txt.” Block 110 reads “DSMCC Carousel Generator”. Block 115 reads “MPEG injector”. Block 121 reads “DSI”. Block 122 reads “DII 1”. Block 123 reads “DII 2”. Block 130 is captioned as “Module 1”. Block 131 reads “File: gateway”. Block 132 reads “File: application”. Block 133 reads “File: code.class”. Block 140 is captioned as “Module 2”. Block 141 reads “File: background.gif”. Block 151 is captioned as “Module 3”. Block 152 reads “File: data.” Block 153 reads “File: content.txt”. Block 161 reads “DSI”. Block 162 reads “Video”. Block 163 reads “DII 1”. Block 164 reads “Audio”. Block 165 reads “Module 1a”. Block 166 reads “Video”. Block 167 reads “Module 1b”. Block 170 reads “Section Filter”. Block 175 reads “Client's DSMCC Module”. Block 181 reads “Application”. Block 182 reads “File”.

Multimedia client platforms such as MHP use DSMCC to broadcast Java MHP applications and their data from a server to a number of clients such as set-top boxes. In FIG. 1, the server and client are shown generally at 100 and 150, respectively. The DSMCC content is typically embedded in a DVB MPEG transport stream 160. In one possible approach, the broadcaster has one or multiple small Java applications, called xlets in MHP, similar to applets in the Internet domain, with associated data and resources that the broadcaster wants to distribute to the clients. The applications include a bundle of files with classes, images and other data files, bundled in one or multiple filesystems. Such a filesystem includes a number of directory files and other files, such as is used on a conventional personal computer (PC). Block 105 represents an example original filesystem that is broadcast from the server 100 to the client 150 to provide the transferred filesystem 180.

The filesystem 105 can be transferred to the client 150 continuously, and repeatedly using a carousel, over the DVB MPEG transport stream 160. The DSMCC Carousel Generator 110 may be used to perform this task. The files, including directory files, of the filesystem 105 which are to be broadcast, are organized in example modules 130, 140 and 151, shown within a low level DSMCC carousel structure 120. One of more files per module may be used. A directory is also considered to be a file. Each DSMCC Object carousel has one DSI 121, the entrance point to the carousel. In particular, the DownloadServerInitiate (DSI) message under the DSMCC standard is a top-level control message for carousels that have several DII messages, such as the first DII message 122 and the second DII message 123. The DSI message groups together a number of DII messages, and the groups of modules associated with them, into a single supergroup. The DownloadInfoIndication (DII) message under the DSMCC standard contains a description of a number of modules and of the parameters that are used to transmit them. Any modules that are listed in the same DII message are said to be members of the same group. This provides a way for broadcasters to identify modules that belong together, for instance because they all carry different parts of a single block of data.

The DSI 121 points to the first DII 122 and to the location of a gateway or root directory of the filesystem. Each DII 122 and 123 refers to one or multiple modules. Each directory contained by a DII, references the DIIs that carry the file contained by that directory.

An MPEG injector 115 injects the modules 130, 140 and 151 into the transport stream 160 in sections. Transport stream packets are the basic containers in, for instance, DVB and ATSC. Each transport stream packet has a header containing a packet identifier (PID). The PID is a number, identifying the transport stream packets that belong to the same elementary stream. For example, the video content of a specific channel is put into transport stream packets having the same PID, which is assigned for use with this video content. The transport stream packets with audio content have another PID. On top of this packet structure, MPEG defines sections, which can be thought of as a container for cyclically broadcasting data. Each section can contain up to 4Kbytes of data. To discriminate between different types of data (such as DII, DSI or module data), sections have an identifier called table identifier (TID). To be able to have multiple sections with the same TID, sections have a section number. Each data type defines which parts of the section data uniquely defines a section number within all sections with the same TID. In one possible approach, the DSI 121, DII 122 and 123 and the modules 130, 140 and 151 are split up and broadcast in sections of 4Kbytes to the client side 150. For example, transport stream packets 161, 163, 165 and 167 carry the filesystem data, while transport stream packets 162, 164 and 166 carry video or audio data.

As a specific example, assume a client set-top box requires the contents of the file ‘\application\code.class’. Conventionally, this is achieved by the client's middleware, e.g., including the DSMCC module 175, performing the following steps:

1. open a section filter to get the module with the DSI,

2. parse the DSI to get the position of the gateway (this is the root directory) and the (first) DII,

3. retrieve the DII,

4. parse the DII so the location of the module with the gateway is known,

5. retrieve all sections for this specific module,

6. reconstruct the module, and

7. get the gateway from the module.

With the gateway, the middleware is able to determine in which DII, module (and at which identifier within this module) the directory ‘application’ is positioned. The steps above are repeated until the file ‘application’ is retrieved and parsed. At this point, finally, the module is known where the file ‘code.class’ is positioned. Again, with the process above, the file ‘code.class’ is retrieved. Depending the carousel configuration, the DSI, DII and the modules can be cached to the DSMCC module 175, which might re-use previously retrieved modules. Appendix B.4 of the MHP 1.0.x specifications (ETSI TS 101 812/TAM232R27, and more recent versions thereof) also contains a description of the low level structure of a broadcast DSMCC carousel, along with various caching strategies to decrease the download time.

However, as mentioned at the outset, the above approach in which the middleware recovers a filesystem from the transport stream is computationally expensive and prone to errors. The present invention speeds up the file retrieval process while avoiding potential errors that can be experienced with the client's middleware. In the present approach, the multimedia service application 181 at the client is provided with the module configuration and file location (within the module) of a specific file. With this information, the application 181 is able to bypass the DSMCC middleware in the client and retrieve a module directly, section by section, to reconstruct the module and to retrieve a desired file 182.

This strategy has various advantages. For example, in case of file updates, the new file is made available much earlier. For example, when a data file is updated, the broadcaster sends a stream event. The client detects the stream event immediately and starts filtering the new module. The new file content should be available after a carousel cycle. An alternative is to use the file detection mechanisms in the MHP middleware, in case the time to get the new file content might vary for different middleware implementations. Furthermore, the disclosed strategy can ensure the new file is guaranteed to become available. The DSMCC mechanism is quite complex, especially with good caching strategies. Bugs and problems in the middleware can result in an incorrect operating application, because file updates are not detected by the middleware. The disclosed strategy avoids such middleware bugs.

Alternatively one might put a file directly into MPEG sections in a proprietary format. However packaging the data according to the DSM-CC protocol is advantageous because it carries the data in a format that is believed to be much more standard, i.e., other standards based on DMSCC may also be able to read and process the same files without having the ability to implement the disclosed strategy of reading the files.

Moreover, the invention can be carried out using the existing conventional broadcast in which a DSMCC object carousel is provided. The invention focuses on recovering specific files from the broadcast at the client in a more efficient way. In particular, the client application 181, such as an MHP application, bypasses the DSMCC mechanism 175 in the middleware, and directly retrieves a file 182 from the broadcast via the section filter 170. The section filter 170 is a mechanism that is present in many client devices such as set-top boxes for recovering sections with a specific header from an MPEG broadcast. To retrieve a file in one filter operation, the application is configured with an associated identifier, such as a packet identifier (PID), of sections in which the modules 130, 140 and 151 are broadcast. The application 181 is also configured with the associated identifier of the module, e.g., a moduleId—module 1, 2 or 3, etc., to configure the section filter 170 so that all sections (containing the module), are filtered and recovered from the broadcast. In one possible approach, only the sections in which the specific module is contained are recovered. In another approach, the filter 170 recovers all modules, and then determines the specific module of interest using the <moduleId>. The application 181 is also configured with an ‘object key’ identifier to determine where a file is positioned inside a module, e.g., first, second, third, etc. Specifically, files are placed in a FileMessage, and directories are placed in a DirectoryMessage. A module contains one or multiple FileMessages and/or DirectoryMessages. A FileMessage or MessageDirectory contains the object key, also referred to as a file key, which uniquely identifies the message. Thus, the object key uniquely identifies a file in a module. Note that one or more desired files can be obtained from a single module using corresponding object keys or other appropriate identifiers.

In another possible approach, only one file can be placed in each module, in which case an object key is not needed to identify a specific file within a module.

Accordingly, the combination of the section identifier (PID), module identifier (moduleId) and object key identifier (objectKey) uniquely defines a desired file. Referring still to the example of FIG. 1, the client can recover the three files in turn, namely (1) \application\code.class, (2) images\background.gif, and (3) \data\content.txt. Moreover, for each desired file, the client application 181 filters the data stream to recover the sections having the specified PID, recover the module having the specified moduleId, and recover the desired file having the specified objectKey. To retrieve a module, the <pid, moduleId> information is needed. Within a module, the objectKey uniquely identifies a file. Note that in DSMCC, DII messages do not refer to each other. A directory has a list of files, and such file has a reference to <pid, transaction id (referring to the DII), moduleId, objectKey>.

Furthermore, when the application 181 has all sections for a specific module, it can check to verify that all sections have the same version number or other identifier. If there is a version mismatch, and no check is made, sections from various module versions will be gathered, and combining these sections will result in a corrupt module. Thus, if the version numbers do not match, the application continues to filter or reopens the filter to attempt to retrieve the module for the second time. When the version numbers of the recovered sections are verified as having a common version identifier, or when the multimedia services application has limited the sections its recovering to the sections having the version identifier it is expecting, it is guaranteed that the reconstructed module is valid, and the application can recover the one or more desired files responsive to the successful verification. This avoids the case where sections with various versions numbers are mixed up in the received data stream. The version number of the sections must correspond to reconstruct a valid module.

FIG. 2 illustrates a block diagram of a server and a client for achieving the transfer of FIG. 1, according to the invention. Block 102 reads “MHP generator”. Block 104 reads “Broadcast Control”. Block 106 reads “Audio and Video encoders”. Block 108 reads “Multiplexer”. Block 252 reads “MHP applications”. Block 254 reads “MHP middleware”. Block 256 reads “Hardware section filter”. Block 258 reads “Video Decoder”. Block 260 reads “Remote control.” Block 262 reads “Video Output”. Block 264 reads “TV”.

At the server 100, the MHP generator 102 generates a DVB stream with DSMCC object carousels and related MHP tables. Audio and Video encoders 106 generate DVB streams with encoded audio and video. The Broadcast Control 104 controls the MHP generator 102 and the audio and video encoders 106, and generates all program-specific information (PSI)/service information (SI) to complete the DVB broadcast. A Multiplexer 108 multiplexes the various DVB streams, which contain audio, video, MHP content and other data, to provide a valid and complete DVB stream to be broadcast to the client 150.

At the client/receiver 150, MHP applications 252, including an application that is analogous to the application 181 of FIG. 1, receive the broadcast MHP data and perform various functions based on the received multimedia data. MHP middleware 254 is a software stack present on the client 150 that is capable of handling MHP broadcasts and executing the MHP applications 252. A hardware section filter 256 can be a hardware component that is capable of filtering DVB sections according the defined filter settings. The application 252 can configure settings of the filter 256 such as by constructing a filter mask such that only the sections of a specified PID and moduleId are passed to the application 252. The filtering can be asynchronous with the application 252 such that the application 252 first configures and starts the filter 256 and, when complete sections are found, they are passed back to the application 252 via a callback mechanism. When all sections to complete a module have arrived, the application 252 stops the filter 256 and reconstructs the module. The filtering itself can be performed in hardware due to the large bandwidth of the received data stream. For example, a DVB stream may be provided at a rate of 40 Mbits/sec., corresponding to 26,600 transport stream packages or packets/sec., each of which is processed by the filter 256.

A Video Decoder 258 decodes audio and video data in a selected service. A Video Output device 262 mixes video from the video decoder 258, and graphics from the MHP middleware 254 to provide a video output signal to a TV 264 or other display device. A remote control device 260 enables the viewer to control and interact with the client 150 and the MHP applications 252.

Note that the client 150 may include memory and processing resources for implementing the functionality described herein. In particular, at least one program storage device may tangibly embody instructions that are executed by at least one processor to achieve the functionality described herein. A memory that stores instructions, such as software, firmware and/or micro code, may be considered a program storage device.

Accordingly, it can be seen that the present invention provides a technique for recovering one or more desired files of a filesystem for use by a multimedia services application at a client. The technique does not require changes in the broadcast, and is applicable to different multimedia services broadcasts, including DSMCC broadcasts. The application is configured with <PID, moduleId, objectKey> identifiers for recovering a specific file. The application performs the module filtering and parsing instead of the DSMCC module in the MHP middleware to provide a faster, more direct and more reliable file recovery.

While there has been shown and described what are considered to be preferred embodiments of the invention, it will, of course, be understood that various modifications and changes in form or detail could readily be made without departing from the spirit of the invention. It is therefore intended that the invention not be limited to the exact forms described and illustrated, but should be construed to cover all modifications that may fall within the scope of the appended claims.

1. A method for recovering at least one desired file of a filesystem (105) from a data stream received at a client, wherein the filesystem is provided in a plurality of modules, and the plurality of modules are provided in a plurality of sections, the method comprising:
configuring a multimedia services application (181, 252) running at the client (150) with information for recovering the at least one desired file (182) from the data stream (160), wherein the information includes: (a) a first identifier for identifying the at least one desired file within one of the plurality of modules (130, 140, 150), and (b) a second identifier for identifying the one of the plurality of modules;
filtering the data stream (256), responsive to the multimedia services application, to recover at least the sections in which the one of the plurality of modules is carried, and, using the second identifier, recover the one of the plurality of modules from the recovered sections; and
using the multimedia services application to recover the at least one desired file from the recovered one of the plurality of modules, according to the first identifier.

2. The method of claim 1, wherein:
the information further includes: (c) a third identifier for identifying sections (161, 163, 165, 167) in which the one of the plurality of modules is carried; and
the filtering uses the third identifier to recover the at least the sections in which the one of the plurality of modules is carried.

3. The method of claim 1, wherein:
the plurality of modules are transmitted from the server to the client in a carousel (110, 120); and
the at least one desired file is recovered in no more than one cycle of the carousel.

4. The method of claim 1, wherein:
the data stream comprises a broadband data stream that is broadcast to a plurality of clients.

5. The method of claim 1, wherein:
the multimedia services application recovers the at least one desired file while Digital Storage Media-Command and Control (DSM-CC) middleware (175, 254) of the client is bypassed.

6. The method of claim 1, wherein:
the multimedia services application comprises a Multimedia Home Platform application.

7. The method of claim 1, wherein:
the filesystem is provided according to a Digital Storage Media-Command and Control (DSM-CC) standard.

8. The method of claim 1, wherein:
the multimedia services application verifies that the recovered sections have a common version identifier.

9. The method of claim 1, wherein:
the sections that are recovered are limited to sections having an expected version identifier.

10. A client (150), comprising:
at least one program storage device tangibly embodying instructions that are executable by at least one processor for providing a multimedia services application (181, 252) for recovering at least one desired file (182) of a filesystem (105) from a received data stream (160), wherein the filesystem is provided in a plurality of modules (130, 140, 150), and the plurality of modules are provided in a plurality of sections (161, 163, 165, 167);
wherein the multimedia services application is configured with information for recovering the at least one desired file from the data stream, wherein the information includes: (a) a first identifier for identifying the at least one desired file within one of the plurality of modules, and (b) a second identifier for identifying the one of the plurality of modules; and
a filter (256) responsive to the multimedia services application (252) for filtering the data stream to recover at least the sections in which the one of the plurality of modules is carried, and, using the second identifier, recovering the one of the plurality of modules from the recovered sections;
wherein the multimedia services application is configured to recover the at least one desired file from the recovered one of the plurality of modules, according to the first identifier.

11. The client of claim 10, wherein:
the information further includes: (c) a third identifier for identifying sections (161, 163, 165, 167) in which the one of the plurality of modules is carried; and
the filter uses the third identifier to recover the at least the sections in which the one of the plurality of modules is carried.

12. The client of claim 10, wherein:
the plurality of modules are transmitted from the server to the client in a carousel (110, 120); and
the desired file is recovered in no more than one cycle of the carousel.

13. The client of claim 10, wherein:
the data stream comprises a broadband data stream that is broadcast to a plurality of clients.

14. The client of claim 10, wherein:
the multimedia services application recovers the at least one desired file while Digital Storage Media-Command and Control (DSM-CC) middleware (175, 254) of the client is bypassed.

15. The client of claim 10, wherein:
the multimedia services application comprises a Multimedia Home Platform application.

16. The client of claim 10, wherein:
the filesystem is provided according to a Digital Storage Media-Command and Control (DSM-CC) standard.

17. The client of clam 10, wherein:
the multimedia services application verifies that the recovered sections have a common version identifier.

18. The client of claim 10, wherein:
the sections that are recovered are limited to sections having an expected version identifier.

19. At least one program storage device tangibly embodying instructions that are executable by at least one processor for performing a method for recovering at least one desired file of a filesystem (105) from a data stream received at a client, wherein the filesystem is provided in a plurality of modules, and the plurality of modules are provided in a plurality of sections, the method comprising:
configuring a multimedia services application (181, 252) running at the client (150) with information for recovering the at least one desired file (182) from the data stream (160), wherein the information includes: (a) a first identifier for identifying the at least one desired file within one of the plurality of modules (130, 140, 150), and (b) a second identifier for identifying the one of the plurality of modules;
filtering the data stream (256), responsive to the multimedia services application, to recover at least the sections in which the one of the plurality of modules is carried, and, according to the second identifier, recover the one of the plurality of modules from the recovered sections; and
using the multimedia services application to recover the at least one desired file from the recovered one of the plurality of modules, according to the first identifier.

20. The at least one program storage device of claim 19, wherein:
the information further includes: (c) a third identifier for identifying sections (161, 163, 165, 167) in which the one of the plurality of modules is carried; and
the filtering uses the third identifier to recover the at least the sections in which the one of the plurality of modules is carried.

21. A method for verifying a recovered file of a filesystem from a data stream received at a client, wherein the filesystem is provided in a plurality of modules, and the plurality of modules are provided in a plurality of sections, the method comprising:
configuring a multimedia services application (181, 252) running at the client (150) with information for recovering the at least one desired file (182) from the data stream (160);
filtering the data stream (256), responsive to the multimedia services application, to recover at least the sections in which the one of the plurality of modules is carried, and recover the one of the plurality of modules from the recovered sections;
verifying that the recovered sections have a common version identifier to ensure the recovered one of the plurality of modules is valid; and
responsive to the verifying, using the multimedia services application to recover the at least one desired file from the recovered one of the plurality of modules.

22. The method of claim 21, wherein:
the sections that are recovered are limited to sections having an expected version identifier.
